(19) United States
(12) Patent Application Publication
(10) Pub. No.: US 2002/0154937 A1
(43) Pub. Date: Oct. 24, 2002

(54) Free ink pen having an open space storage in a feeder for holding excess liquid

(75) Inventors: Reza Mehrabi, Tujunga, CA (US); Dale Harder, Placentia, CA (US)

Correspondence Address: Squire, Sanders & Dempsey L.L.P., 801 S. Figueroa Street, 14th Fl., Los Angeles, CA, 90017-5554, US

(73) Assignee: Avery Dennison Corporation

(21) Appl. No.: 09/839,380

(22) Filed: Apr. 20, 2001

(51) Int. Cl. B43K 8/06; B43K 8/14

(52) U.S. Cl. 401/198; 401/17; 401/23; 401/196

(57) ABSTRACT

The present provides a porous plug between a reservoir and a feeder having an open space therein to store the excess liquid as the underpressure within the reservoir subsides, i.e., higher absolute pressure. That is, as excess liquid conveys through the porous plug and then to the feeder, liquid take the path of least resistance, which in this case is the open space within the feeder. As liquid enters the open space, air within the open space is displaced through larger capillaries in the feeder. The displacement of air creates an slight vacuum or underpressure within the open space itself to hold the liquid inside the open space until the underpressure within the open space rises, i.e., lower absolute pressure. And as the underpressure within the reservoir rises, liquid in the feeder and the open space are drawn back into the reservoir

### BACKGROUND OF THE INVENTION

1. Field of the Invention

The present invention relates generally to liquid dispensing utensils and, more particularly, to a free ink pen which has an open space within a feeder for storing excess liquid.

2. Description of the Related Art

Free ink pens are commonly used to deliver liquids such as ink, paint, adhesives, shoe polish, lotion, medicine, perfume, makeup, white out and food. In one type of fluid dispensing utensil, a relatively large volume of fluid is stored in a non-capillary container (or reservoir) where it is allowed to move freely. Pens, which incorporate such a container, for example, are referred to as “free ink” pens or markers. U.S. Pat. No. 6,095,707 issued to Kauffmann discloses such a pen. That is, the ink in the reservoir is usually in a liquid state, and is free to move about as the writing utensil is moved. One of the nice features of free ink markers is that they are visually appealing to users as the liquid moves around within the container. Moreover, free ink markers tend to last longer than other pens.

Liquid in these utensils is transferred from the container to the delivery end (often referred to as a tip or a nib) via a capillary conveying line (sometimes referred to as a feeder). A slight vacuum (underpressure) relative to the atmosphere is maintained within the container which prevents liquid in the conveying line from escaping from the utensil until the tip is brought into contact with the surface onto which liquid is to be dispensed. At this point, the force of attraction of the surface and the capillary force of the space between the surface and portions of the tip, which are not in direct contact with the surface, will cause the liquid to flow from the tip to the surface. As liquid is dispensed, air enters the container in a controlled manner via an air inlet that is formed in the container and ends within the liquid reservoir. The air replaces the liquid so as to maintain the vacuum at a relatively constant level.

To deal with the problem of leakage caused by air expansion within the container, a capillary storage is used to absorb the excess liquid. Specifically, when the air within the container is heated it expands. Alternatively, as the free ink pen is used in a higher elevation, the underpressure within the container will subside, i.e., the relative pressure within the container will rise whem compared to the atmospheric pressure. This forces excess liquid to flow through the conveying line via capillaries. To handle the excess liquid, some ink pens or markers include an overflow chamber having a capillary storage that will absorb the excess ink. Fountain pens, for example, include a capillary storage in the front section and sometimes under the nib. This storage has a capillarity that is strong enough to prevent leakage when the pen is held in the writing position, but not so strong that it will be filled during a normal writing operation. Thus, to optimize the performance of the free ink pen, the pore sizes of the conveying line and storage capillaries need to be carefully controlled.

Moreover, the largest pore size in the conveying line needs to be carefully controlled as well. If the largest pore size in the conveying line is too large, then the underpressure within the container may not be held at a relatively constant level because too much air may be flowing into the container. With the underpressure subsiding in the container, excess ink would flow through the conveying line and overwhelm the storage capillary, and ultimately would leak through the nib. On the other hand, if the largest pore size in the conveying line is too small, the underpressure within the container would increase because not enough air is entering the container to relieve the underpressure. This would restrict the flow of ink through the conveying line, thereby drying out the nib. Controlling the largest pore size in the conveying line, however, may be difficult. That is, with current manufacturing methods, the largest pore size in one conveying line may vary from one conveying line to another conveying line, such that one free ink pen may not perform the same as another free ink pen.

Besides controlling the pore sizes in the conveyor line and the capillary storages, the diameter of the capillary storage generally determines the circumference of the free ink pen because the capillary storage is generally wrapped around the conveying line which means the container for the free ink pen must be at least as large as the capillary storage. This generally means that the free ink pen having a capillary storage is relatively thicker than a ballpoint pen, for example. Therefore, a free ink pen may not be comfortable for a user to write.

Therefore, there is still a need for a free ink pen utilizing the free ink technology that is more comfortable to use without the need for a capillary storage that adds to the cost of manufacturing and makes the circumference of the pen larger.

### BRIEF SUMMARY OF THE INVENTION

One of the features of the present invention is to provide a free ink pen having a relatively small circumference so that it may be comfortably held in a user's hand for writing. Another feature is to provide a free ink pen without a separate capillary storage to reduce the cost of manufacturing yet provide a storage capacity to hold excess liquid that conveys out of the reservoir due to increase in underpressure within the container.

The present invention accomplishes the above feature by providing a porous plug between a reservoir and a feeder having an open space therein to store the excess liquid as the underpressure within the reservoir subsides, i.e., higher absolute pressure. That is, as excess liquid conveys through the porous plug and then to the feeder, liquid takes the path of least resistance, which in this case is the open space within the feeder. As liquid enters the open space, air within the open space is displaced through larger capillaries in the feeder. The displacement of air creates an slight vacuum or underpressure within the open space itself to hold the liquid inside the open space until the underpressure within the open space rises, i.e., lower absolute pressure. And as the underpressure within the reservoir rises, liquid in the feeder and the open space are drawn back into the reservoir

Put differently, the above feature is accomplished by providing a container; a first porous plug within the container having a measurable distribution of pore sizes defining a mean first plug flow pore; a first feeder having a proximal end and a distal end, the distal end of the first feeder within the container and an opening at least partially through the first feeder, the first feeder having a measurable distribution of pore sizes defining a mean first feeder flow pore; the first porous plug between a reservoir portion of the container and the distal end of the first feeder, and the mean first feeder flow pore being smaller than the mean first plug flow pore.

The above described and many other features and attendant advantages of the present invention will become apparent from a consideration of the following detailed description when considered in conjunction with the accompanying drawings.

### BRIEF DESCRIPTION OF THE DRAWINGS

FIG. 1 is an exemplary cross-sectional view of a free ink pen in accordance with one embodiment of the present;

FIG. 2 is an exemplary cross-sectional view of another embodiment of the present invention;

FIG. 3 is an exemplary cross-sectional view of yet another alternative embodiment of the present invention; and

FIG. 4 is an exemplary graph generally illustrating a distribution of pore sizes between a feeder and a porous plug.

### DETAILED DESCRIPTION OF THE INVENTION

This description is not to be taken in a limiting sense, but is made merely for the purpose of illustrating the general principles of the invention. The section titles and overall organization of the present detailed description are for the purpose of convenience only and are not intended to limit the present invention.

By way of background, it should be noted that the descriptive term “capillarity” has been used herein to indicate the height up to which a liquid ascends within a pore of a given diameter. The greater the height, the greater the capillarity. In general, small size pores have greater capillarity than the larger size pores. In other words, the term “capillarity” is indicative of the attractive force between a liquid and a pore. Moreover, U.S. Pat. Nos. 6,089,776, 6,183,155 B1, and U.S. Pat. application Ser. No. 09/591,114 filed Jun. 9, 2000, entitled “Efficient Fluid Dispensing Utensil” are all hereby incorporated by reference into this patent application.

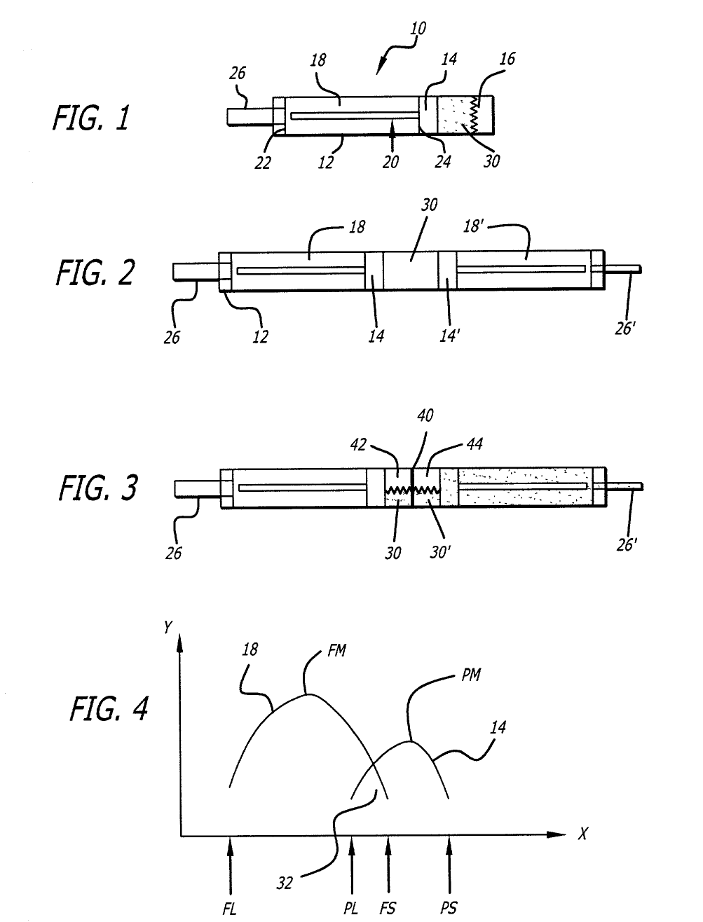

FIG. 1 illustrates by example a free ink pen 10 having a container 12. Within the container 10 is a porous plug 14 defining a reservoir 16 and a feeder 18 having a proximal end 22 and a distal end 24. Within the reservoir 16 is liquid 30. The feeder 18 has an open space 20 that is partially through the feeder 18 as illustrated in FIG. 1. Alternatively, the open space 20 may be all the way through the feeder 18. Moreover, the porous plug 14 is in direct contact with the distal end of the feeder 18. Also, a nib 26 is in direct contact with the proximal end 22 of the feeder 18 to deliver the liquid from the reservoir 16 to a writing surface such as a paper. Alternatively, the proximal end 22 may be formed to be a tip to deliver liquid to a writing surface.

FIG. 4 illustrates by way of example a general distribution of pore sizes between the feeder 18 and the porous plug 14. With regard to the graph in FIG. 4, axis “X” represents a capillarity potential of pores or smaller pore sizes from left to right, and axis “Y” generally represents percentage pores. Moreover, graphs 14 and 18 illustrate exemplary measurable distribution of pore sizes in the porous plug and feeder, respectively. Reference points “FL” refers to a measurable largest pore size in the feeder, “FM” refers to a measurable mean flow pore in the feeder, and “FS” refers to a measurable smallest pore size in the feeder, “PL” refers to a measurable largest pore size in the porous plug, “PM” refers to a measurable mean flow pore in the porous plug, and “PS” refers to a measurable smallest pore size in the porous plug. Note that with above distribution of pore sizes, there is an overlap 32 between the smallest pore size in the feeder and the largest pore size in the porous plug. Moreover, since the liquid 30 is in direct contact with the porous plug 14 and because the capillarity force in the porous plug 14 is greater than the feeder 18, the porous plug 14 will remain wetted. And since there is the overlap region 32, at least a portion of the feeder 18 is wetted. The pore size in the porous plug and feeder may be measured by Porous Materials, Inc., located at 83 Brown Road, Ithaca, N.Y. 14850.

With the above distribution of pore sizes between the porous plug 14 and the feeder 18, as the underpressure within the reservoir subsides, i.e., increase in absolute pressure within the reservoir, liquid 30 within the reservoir will convey through the porous plug 14 and then through a path of least resistance which in this case is the open space 20. That is, at least some of the excess liquid 30 will convey through the feeder 18 and drop into the open space 20. As liquid 30 enters the open space 20, preexisting air within the open space 20 will flow out of the open space through the largest pore or larger pores in the feeder. The introduced ink in open space 20 wets the area around it in the feeder 18, thereby sealing the remaining air in space 20 from the outside. In this way, the open sapce 20 with the introduced ink acts as a small version of reservoir 16.

Once the underpressure within the reservoir rises, i.e., decrease in absolute pressure within the reservoir, liquid in the porous plug is drawn back into the reservoir 16. And the porous plug will draw liquid from the feeder and the open space.

When the free ink pen 10 is used for writing, liquid 30 conveys through the porous plug 14, feeder 18, nib 26, and ultimately to a writing surface, as liquid leaves the reservoir, rise in underpressure within the reservoir is relieved through transferring air within the open space 20 through the largest pore size “PL” in the porous plug and into the reservoir. This causes rise in underpressure within the open space itself. To maintain the underpressure within the open space 20, air is drawn in from the atmosphere through the largest pore size in the feeder. With regard to respective underpressure within the reservoir 16 and the open space 20, they are largely dependent on the largest pore size in the porous plug 14 and feeder 18, respectively.

FIG. 2 illustrates by way of example an alternative embodiment of the present invention, where a porous plug 14′ and a feeder 18′ with similar relative pore size distribution as discussed in FIG. 4, but with different pore sizes may be used on the opposite side to use both ends of the marker for writing.

FIG. 3 illustrates by way of example a wall 40 defining a first reservoir area 42 and second reservoir area 44 so that different liquids 30 and 30′ may be used for writing on the two nibs 26 and 26′, respectively.

There are number of advantages to the present invention, without the need for a capillary storage the circumference of the free ink pen 10 may be reduced so that a user can hold it more comfortably. Moreover, without the need for a capillary storage, the free ink pen may be manufactured at a less cost. Still further, since the liquid in the open space is near the nib in an upright position, the nib may convey the liquid from the open space with less resistance to provide sufficient liquid flow when additional liquid is needed while writing fast for example.

In closing, it is noted that specific illustrative embodiments of the invention have been disclosed hereinabove. However, it is to be understood that the invention is not limited to these specific embodiments. Alternatively, the opening space 20 may extend through the proximal end 22 and the distal end 24 and the nib 26 inserted within the opening in the proximal end 22 of the feeder 18. Still further, open space may be formed between the feeder and the container 12. That is, the feeder may run along the central longitudinal axis and the open space formed between the outer circumference of the feeder and the inner wall of the container. With regards to liquid, it may be solvent-based ink or water base ink or any other ink known to one skilled in the art.

With respect to the claims, it is applicant's intention that the claims not be interpreted in accordance with the sixth paragraph of 35 U.S.C. § 112 unless the term “means” is used followed by a functional statement.

What is claimed is:

1. A free ink pen, comprising:
a container;
a first porous plug within the container having a measurable distribution of pore sizes defining a mean first plug flow pore;
a first feeder having a proximal end and a distal end, the distal end of the first feeder within the container and an opening at least partially through the first feeder, the first feeder having a measurable distribution of pore sizes defining a mean first feeder flow pore;
the first porous plug between a reservoir portion of the container and the distal end of the first feeder, and
the mean first feeder flow pore being smaller than the mean first plug flow pore.

2. A free ink pen according to claim 1, further including a nib protruding from the container and coupled to the proximal end of the first feeder.

3. A free ink pen according to claim 1, wherein the opening is through the first feeder wherein the distal end of the first feeder is coupled to the first porous plug and a nib is within the opening of the proximal end of the first feeder.

4. A free ink pen according to claim 1, wherein the measurable distribution of pore sizes in the first porous plug defines a largest pore size and the smallest pore size, and the measurable distribution of pore sizes in the first feeder defines a largest pore size and the smallest pore size.

5. A free ink pen according to claim 4, wherein the smallest pore size of the first feeder is smaller than the largest pore size of the first porous plug.

6. A free ink pen according to claim 5, wherein the smallest pore size of the first feeder is substantially similar to the largest pore size of the first porous plug.

7. A free ink pen according to claim 4, wherein the largest pore size in the first feeder is greater than the largest pore size in the first porous plug.

8. A free ink pen according to claim 1, wherein the liquid is a solvent base ink.

9. A free ink pen according to claim 8, wherein the largest pore size in the first porous plug is about 45 microns to about 20 microns.

10. A free ink pen according to claim 1, wherein the liquid is a water base ink.

11. A free ink pen according to claim 10, wherein the largest pore size in the first porous plug is about 50 microns to about 30 microns.

12. A free ink pen according to claim 1, further including:
a second porous plug within the container having a measurable distribution of pore sizes defining a mean second plug flow pore;
a second feeder having a proximal end and a distal end, the distal end of the second feeder within the container and an opening at least partially through the second feeder, the second feeder having a measurable distribution of pore sizes defining a mean second feeder flow pore;
the second porous plug between the reservoir portion of the container and the distal end of the second feeder, the reservoir between the first distal end of the first feeder and the second distal end of the second feeder; and
the mean second feeder flow pore being smaller than the mean second plug flow pore.

13. A free ink pen according to claim 12, further including a divider wall between the first distal end of the first feeder and the second distal end of the second feeder, defining a first reservoir filled with first liquid and a second reservoir filled with second liquid.

14. A free ink pen according to claim 13, wherein the first liquid is different from the second liquid.
